(19) United States
(12) Patent Application Publication
(10) Pub. No.: US 2023/0393775 A1
(43) Pub. Date: Dec. 7, 2023

(54) HEALTH EVALUATION FOR A DISTRIBUTED STORAGE SYSTEM

(71) Applicant: VMware, Inc., Palo Alto, CA (US)

(72) Inventors: Yu WU, Shanghai (CN); Pete KOEHLER, Snoqualmie, WA (US); Pushkaraj MIRAJKAR, Oakland, CA (US); Junchi ZHANG, San Jose, CA (US); Jin FENG, Shanghai (CN)

(73) Assignee: VMware, Inc., Palo Alto, CA (US)

(21) Appl. No.: 17/873,700

(22) Filed: Jul. 26, 2022

(30) Foreign Application Priority Data
Jun. 7, 2022 (WO) PCT/CN2022/097304

(51) Int. Cl. G06F 3/06

(52) U.S. Cl. CPC G06F 3/0653; G06F 3/067; G06F 3/0617

(57) ABSTRACT

The health of a distributed storage system provided by a virtualized computing environment may be evaluated. The evaluation techniques categorize health issues based on at least three categories (e.g., storage data availability and accessibility, storage data performance, and storage space utilization and efficiency), and provide priority levels for the health issues within each category. In this manner, a more user-oriented approach is provided wherein in addition to identifying health issues, the priority/urgency level of the health issue(s) can be provided so as to guide the user (such as a system administrator) in determining an appropriate remedial action to perform and when such remedial action should be performed to address health issues.

### CROSS-REFERENCE TO RELATED APPLICATION

The present application claims the benefit of Patent Cooperation Treaty (PCT) Application No. PCT/CN2022/097304, filed Jun. 7, 2022, which is incorporated herein by reference.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

A software-defined approach may be used to create shared storage for VMs and/or for some other types of entities, thereby providing a distributed storage system in a virtualized computing environment. Such software-defined approach virtualizes the local physical storage resources of each of the hosts and turns the storage resources into pools of storage that can be divided and accessed/used by VMs or other types of entities and their applications. The distributed storage system typically involves an arrangement of virtual storage nodes that communicate data with each other and with other devices.

It can be challenging to effectively and efficiently evaluate the health of a distributed storage system. Evaluating health issues (including determining their priority/urgency levels) can be challenging in distributed storage systems that are large-scale and deployed in a complex computing environment.

### BRIEF DESCRIPTION OF DRAWINGS

FIG. 1 is a schematic diagram illustrating an example virtualized computing environment that can implement a health evaluation technique for a distributed storage system;

FIG. 2 is a schematic diagram illustrating example components that may be used to perform health evaluation for the distributed storage system;

FIG. 3 is a flowchart of an example health evaluation method that can be performed by one or more of the components in FIG. 2 in the virtualized computing environment of FIG. 1;

FIGS. 4 is a flowchart of an example method to evaluate the health of a distributed storage system's data availability and accessibility;

FIGS. 5A and 5B are flowcharts of an example method to evaluate the health of a distributed storage system's performance; and

FIG. 6 is a flowchart of an example method to evaluate the health of a distributed storage system's storage space utilization and efficiency.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be implemented in connection with other embodiments whether or not explicitly described.

The present disclosure addresses various drawbacks associated with evaluating health issues in a distributed system, such as a distributed storage system provided by a virtualized computing environment. Evaluation techniques in accordance with various embodiments categorize health issues based on at least three categories (e.g., storage data availability and accessibility, storage data performance, and storage space utilization and efficiency), and provide priority levels for the health issues within each category. In this manner, a more user-oriented approach is provided wherein in addition to identifying health issues, the priority/urgency level of the health issue(s) can be provided so as to guide the user (such as a system administrator) in determining an appropriate remedial action to perform and when such remedial action should be performed.

The embodiments provided herein enable a faster and more effective way to evaluate the overall health status of a distributed storage system, which is an important and useful capability for virtualization system administrators, technical support engineers, and other users, consumers, etc. Problems in the distributed storage system should be understood correctly so as to allow for swift and deliberate action(s) to resolve issues expediently and effectively. The monitoring of distributed storage systems can be challenging, especially at scale, as there may be many clusters of storage nodes that are comprised of large numbers of servers with local attached storage devices, all connected through a network. The embodiments disclosed herein enable health issues in such complex storage environments to be monitored, evaluated, and addressed.

In such a complex storage environment, it may be rather common to encounter many kinds of hardware/software failures or various performance spike behaviors. Hence, there typically may not be standard answer as to what is good or bad health for such distributed storage systems. Some conventional approaches just evaluate the overall health of a distributed storage system, by simply summing up all health issues that are detected (possibly with optimization approaches that introduce weight according to severity of issues). However, such conventional approaches are rather naïve and cannot be easily implemented or understood by a user (e.g., a system administrator). For example, distributed storage systems are unique in that they may frequently exhibit behaviors that are expected for the distributed storage system, but such behavior(s) could potentially be misinterpreted by the system administrator as being indicative of bad health.

As a result, the overall health status may often be determined to be below expectations, if being evaluated using conventional evaluation approaches, thereby making such conventional approaches less useful from the user perspective. Rather, what would be useful and beneficial for the user, with respect to the evaluation of the distributed storage system, would be knowing at least the following:
Is there any remedial action that is needed for the current state of the distributed storage system in order to address a health issue?
If yes, then what is the priority and urgency level of the health issue?
After confirming the priority/urgency level, what is the potential impact of the health issue? The potential impact can guide the user in determining an appropriate remedial action to be performed, including provisioning new resources, contacting third parties (such as software and/or hardware vendors for products and support), etc.

Various embodiments of the health evaluation techniques disclosed herein address the foregoing three questions above, in a manner that allows a system administrator or other user to easily identify and take corrective action when a health issue arises in a distributed storage system and is identified. At least the following benefits/advantages may be provided by the embodiments of the health evaluation technique:
The evaluation technique is user-oriented, in that instead of just reporting all kinds of health issues, the evaluation technique provides priority/urgency information so as to guide the user in determining an appropriate remedial action and when such remedial action should be performed.
The evaluation technique is based on a flexible framework that may be applied to any distributed storage system with a similar infrastructure.

Computing Environment with Health Evaluator

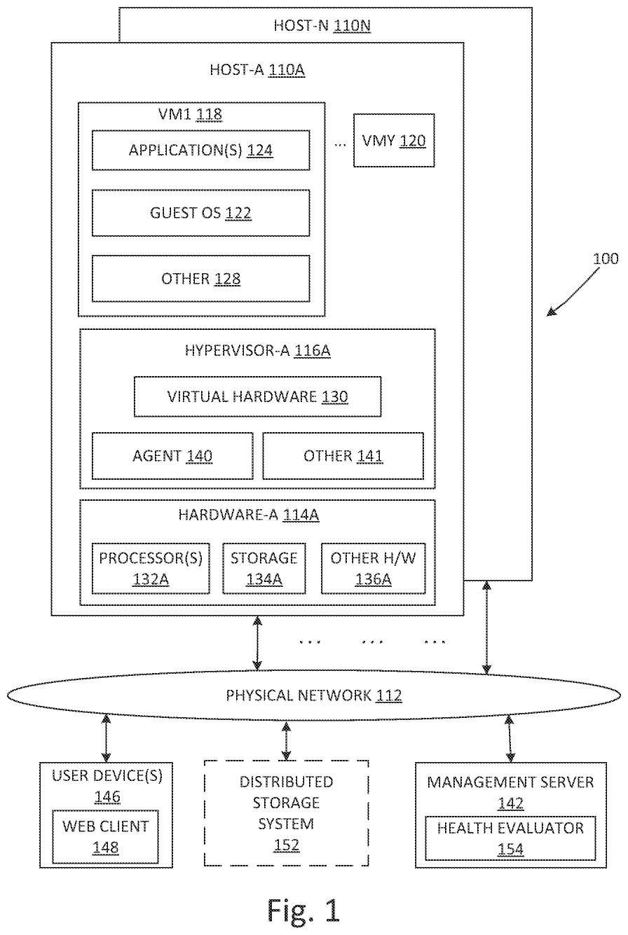

Various implementations will now be explained in more detail using FIG. 1, which is a schematic diagram illustrating an example virtualized computing environment 100 that can implement a health evaluation technique for a distributed storage system. Depending on the desired implementation, the virtualized computing environment 100 may include additional and/or alternative components than that shown in FIG. 1.

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of host-A 110A. Each of the other hosts can include substantially similar elements and features.

The host-A 110A includes suitable hardware-A 114A and virtualization software (e.g., hypervisor-A 116A) to support various virtual machines (VMs). For example, the host-A 110A supports VM1 118 . . . VMY 120, wherein Y (as well as N) is an integer greater than or equal to 1. In practice, the virtualized computing environment 100 may include any number of hosts (also known as “computing devices”, “host computers”, “host devices”, “physical servers”, “server systems”, “physical machines,” etc.), wherein each host may be supporting tens or hundreds of virtual machines. For the sake of simplicity, the details of only the single VM1 118 are shown and described herein.

VM1 118 may include a guest operating system (OS) 122 and one or more guest applications 124 (and their corresponding processes) that run on top of the guest operating system 122. VM1 118 may include still further other elements 128, such as a virtual disk, agents, engines, modules, and/or other elements usable in connection with operating VM1 118, including using or otherwise interacting with a distributed storage system 152.

The hypervisor-A 116A may be a software layer or component that supports the execution of multiple virtualized computing instances. The hypervisor-A 116A may run on top of a host operating system (not shown) of the host-A 110A or may run directly on hardware-A 114A. The hypervisor-A 116A maintains a mapping between underlying hardware-A 114A and virtual resources (depicted as virtual hardware 130) allocated to VM1 118 and the other VMs. The hypervisor-A 116A of some implementations may include/run one or more health monitoring agents 140 to monitor for health issues in the distributed storage system 152, in the host-A 110A, in the VMs running on the host-A 110A etc.

In some implementations, the agent 140 may reside elsewhere in the host-A 110A (e.g., outside of the hypervisor-A 116A), including running in a VM in some embodiments. In still other embodiments, the agent 140 may alternatively or additionally reside in a management server 142 and/or elsewhere in the virtualized computing environment 100, so as to monitor the health of hosts, network(s), the distributed storage system 152, and/or other components in the virtualized computing environment.

The hypervisor-A 116A may include or may operate in cooperation with still further other elements 141 residing at the host-A 110A. Such other elements 141 may include drivers, agent(s), daemons, engines, virtual switches, and other types of modules/units/components that operate to support the functions of the host-A 110A and its VMs, as well as functions associated with using storage resources of the host-A 110A for distributed storage.

Hardware-A 114A includes suitable physical components, such as CPU(s) or processor(s) 132A; storage resources(s) 134A; and other hardware 136A such as memory (e.g., random access memory used by the processors 132A), physical network interface controllers (NICs) to provide network connection, storage controller(s) to access the storage resources(s) 134A, etc. Virtual resources (e.g., the virtual hardware 130) are allocated to each virtual machine to support a guest operating system (OS) and application(s) in the virtual machine, such as the guest OS 122 and the applications 124 in VM1 118. Corresponding to the hardware-A 114A, the virtual hardware 130 may include a virtual CPU, a virtual memory, a virtual disk, a virtual network interface controller (VNIC), etc.

Storage resource(s) 134A may be any suitable physical storage device that is locally housed in or directly attached to host-A 110A, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, integrated drive electronics (IDE) disks, universal serial bus (USB) storage, etc. The corresponding storage controller may be any suitable controller, such as redundant array of independent disks (RAID) controller (e.g., RAID 1 configuration), etc.

The distributed storage system 152 may be connected to each of the host-A 110A . . . host-N 110N that belong to the same cluster of hosts. For example, the physical network 112 may support physical and logical/virtual connections between the host-A 110A . . . host-N 110N, such that their respective local storage resources (such as the storage resource(s) 134A of the host-A 110A and the corresponding storage resource(s) of each of the other hosts) can be aggregated together to form a shared pool of storage in the distributed storage system 152 that is accessible to and shared by each of the host-A 110A . . . host-N 110N, and such that virtual machines supported by these hosts may access the pool of storage to store data. In this manner, the distributed storage system 152 is shown in broken lines in FIG. 1, so as to symbolically convey that the distributed storage system 152 is formed as a virtual/logical arrangement of the physical storage devices (e.g., the storage resource(s) 134A of host-A 110A) located in the host-A 110A . . . host-N 110N. However, in addition to these storage resources, the distributed storage system 152 may also include stand-alone storage devices that may not necessarily be a part of or located in any particular host.

According to some implementations, two or more hosts may form a cluster of hosts that aggregate their respective storage resources to form the distributed storage system 152. The aggregated storage resources in the distributed storage system 152 may in turn be arranged as a plurality of virtual storage nodes. Other ways of clustering/arranging hosts and/or virtual storage nodes are possible in other implementations.

The management server 142 (or other network device configured as a management entity) of one embodiment can take the form of a physical computer or with functionality to manage or otherwise control the operation of host-A 110A . . . host-N 110N, including operations associated with the distributed storage system 152. In some embodiments, the functionality of the management server 142 can be implemented in a virtual appliance, for example in the form of a single-purpose VM that may be run on one of the hosts in a cluster or on a host that is not in the cluster of hosts. The management server 142 may be operable to collect usage data associated with the hosts and VMs, to configure and provision VMs, to activate or shut down VMs, to monitor health conditions and evaluate and prioritize operational issues that pertain to health, and to perform other managerial tasks associated with the operation and use of the various elements in the virtualized computing environment 100 (including managing the operation of and accesses to the distributed storage system 152).

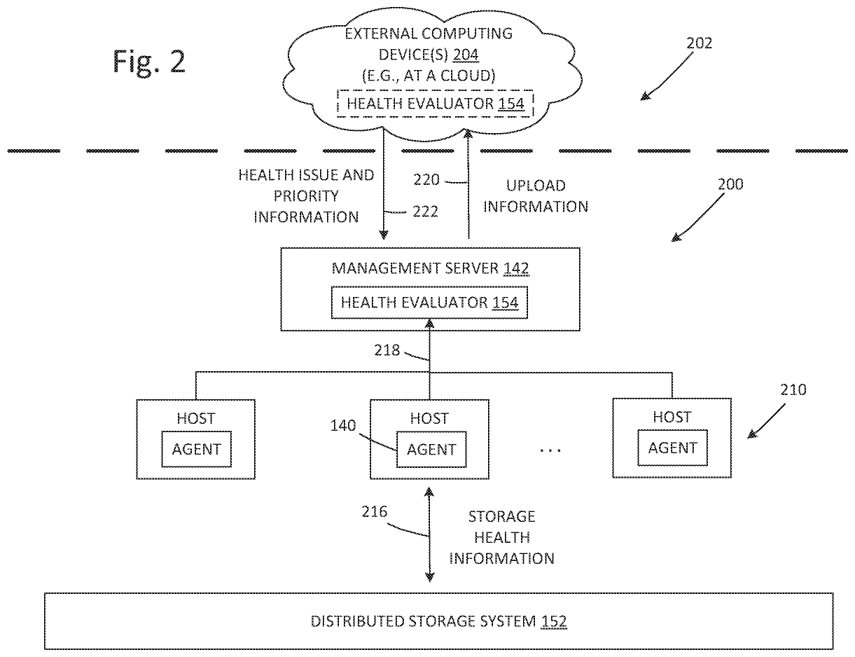

In some embodiments, a health evaluator 154 (described in further detail with respect to FIG. 2 and other subsequent figures below) may reside in the management server 142 and/or elsewhere in the virtualized computing environment 100. The health evaluator 154 may be embodied in software and/or hardware, and as will be described in further detail below, may be configured receive health information pertaining to the distributed storage system 152, hosts, and/or other components in the virtualized computing environment 100, categorize and prioritize health issues and corresponding remedial actions, determine impacts of health issues, provide recommendations for remedial actions, etc.

The management server 142 may be a physical computer that provides a management console and other tools that are directly or remotely accessible to a system administrator or other user. The management server 142 may be communicatively coupled to host-A 110A . . . host-N 110N (and hence communicatively coupled to the virtual machines, hypervisors, hardware, distributed storage system 152, etc.) via the physical network 112. In some embodiments, the functionality of the management server 142 may be implemented in any of host-A 110A . . . host-N 110N, instead of being provided as a separate standalone device such as depicted in FIG. 1.

A user may operate a user device 146 to access, via the physical network 112, the functionality of VM1 118 . . . VMY 120 (including operating the applications 124), using a web client 148. The user device 146 can be in the form of a computer, including desktop computers and portable computers (such as laptops and smart phones). In one embodiment, the user may be an end user or other consumer that uses services/components of VMs (e.g., the application 124) and/or the functionality of the distributed storage system 152. The user may also be a system administrator that uses the web client 148 of the user device 146 to remotely communicate with the management server 142 via a management console for purposes of performing management operations, including health-related operations pertaining to the distributed storage system 152.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

FIG. 2 is a schematic diagram illustrating example components that may be used to perform health evaluation for the distributed storage system 152 in the virtualized computing environment of FIG. 1. In FIG. 2, an internal network 200 (e.g., a customer environment or other private network environment) and an external network 202 (e.g., a cloud environment) are shown. The internal network 200 includes a plurality of hosts 210 (e.g., the host-A 110A . . . host-N 110N shown in FIG. 1) that are configured to provide storage resources for the distributed storage system 152. The operation of the hosts 210 is managed by one or more management servers 142.

In operation, the agent 140 (also shown in FIG. 1), which resides at each host in the implementation depicted in FIG. 2 by way of example, collects (at 216) health information (e.g., performance metrics, statistics, etc., all of which are labeled as storage health information in FIG. 2) from the distributed storage system 152. The agents 140 may also collect information pertaining to the health of the hosts, the VMs running on the hosts, and/or other health-related information regarding components of the internal network 200. As an example, the storage health information that is collected and/or compiled by each agent 140 may include any suitable type of information that pertains to the health of the distributed storage system 152, including information that provides indicators of reduced capacity, reduced availability, throughput and latency, corrupted storage, input/output (I/O) characteristics, network partitions, etc.

The health evaluator 154 (e.g., a service, agent, daemon, or other component) then collects (at 218) this storage health information (and/or other health information) from each of the managed hosts 210. In the embodiment depicted in FIG. 2, the health evaluator 154 is depicted as residing at the management server 142. The health evaluator 154 may reside elsewhere in the internal network 200 in other embodiments, including being distributed amongst multiple devices.

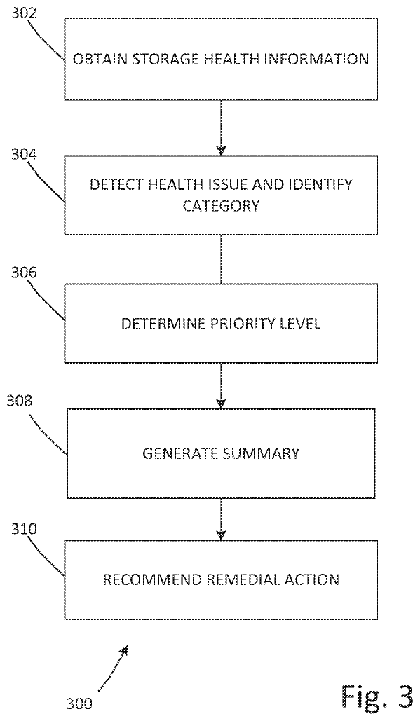

As will be described in further detail with respect to FIG. 3 and the subsequent figures, the health evaluator 154 may process the received health information so as to determine and categorize health issues that may be present in the distributed storage system 152, and then prioritize the health issues. The health evaluator 154 may then present the health issue information and priority information on a management console (e.g., at the web client 148 at the user device 146) for review and initiation of an appropriate remedial action by a user such as a system administrator.

While the foregoing has described an embodiment wherein the health evaluator 154 resides and performs its operations within the internal network 200, other embodiments may be provided wherein the health evaluator 154 resides in the external network 202. The external network 202 may include one or more computing devices 204 deployed at a cloud (e.g., a public cloud or a private cloud), for purposes of simplicity of explanation and as examples hereinafter in some of the disclosed embodiments—the computing devices 204 of other embodiments may be deployed in various types of external network arrangements that may not necessarily be arranged as a cloud environment.

In such embodiments, the health evaluator 154 (shown in broken lines at the external network 202) may receive uploaded health information (at 220) from the management server 142 and/or from some other devices within the internal network 200. The health evaluator 154 may then perform operations to identify, categorize, and prioritize health issues, based on the health information that has been uploaded at 220. The health issue information (including categorization) and priority information may then be sent to the management server 142 (at 222) for evaluation by the user via the management console.

According to various embodiments, the health evaluator 154 may provide output (based on the health information that it processes), such as:
1. An overall summary of action items or detected health issues, with example assigned priority levels that range from P0 (e.g., most critical) to P4 (e.g., least critical). Examples of the output of the health evaluator 154 pertaining to health issues, based on priority levels P0-P4, may include the following:
   a. A number of immediate action items (e.g., the most critical health issues, corresponding to priority level P0).
   b. A number of must-have action items without immediate urgency (e.g., relatively less-critical health issues, corresponding to priority level P1).
   c. A number of low attention action items (e.g., still further relatively less-critical health issues, corresponding to priority level P2).
   d. A number of for-your-information (FYI) items (e.g., health issues that may not need to be addressed, corresponding to priority level P3).
   e. No health issues detected, and so no action is needed (e.g., corresponding to priority level P4).
2. For each health issue (e.g., action item), the health evaluator 154 may include the following example information:
   a. An indication of whether there is a user-visible impact (e.g., corresponding to priority levels P0 and/or P1 for significant user-visible impact, and the other priority levels for relatively less visible impacts).
   b. Any other supportive information, such as recommendations for remedial actions, predictions of risks/results of the health issue remains unaddressed, etc.

It is understood that the number of priority levels may vary from one implementation to another, and need not be strictly organized as priority levels P0-P4. For example, some implementations may use fewer priority levels, while other implementations may use a greater number of priority levels. Moreover, the assignment of a particular priority level to a particular health issue (action item) may also vary from one implementation to another. For example, one distributed storage system may experience a particular health issue that may be deemed to be priority level P1 and therefore requires a must-have remedial action, while the same/similar health issue may be deemed to be priority level P0 in a second distributed storage system and therefore requires immediate remedial action.

A next consideration for the health evaluator 154 is how to categorize the action items with different priority levels and user-visible impacts. According to various embodiments, there may typically be three primary health-related categories for distributed storage systems:
1. Storage data availability and accessibility
2. Storage data performance
3. Storage space utilization and efficiency

The three categories 1-3 above may be viewed as types of key performance indicators (KPIs) or analogous type of health indicators for a distributed storage system. For instance, any health issue that affects in-use data availability and accessibility (or more generally, a data accessibility health issue) of category 1 should be considered as top priority, then followed by performance of category 2, and then space utilization and efficiency of category 3. One or more priority levels can be assigned by the health evaluator 154 to each of the three categories, so that all health issues under a given category will share the same priority level(s). It is also possible for the health evaluator 154 to assign differing priority levels to various individual health issues that are categorized within each of these performance indicators (categories).

As an example, a category can be used to determine the priority for a specific health issue by evaluating which actual impacted category that specific health issue should falls under. For instance, under normal circumstances, the high space utilization health issue under category 3 should have a lower priority level than priority level P0 that requires immediate remedial action—that is, with a high space utilization condition in the distributed storage system 152, data and/or storage space is still available and accessible albeit at a non-optimal condition. However, if storage space reaches a nearly full condition, which may cause the whole distributed storage system 152 to become inoperative with actual data availability impacts, then the priority level for the space utilization condition should be priority level P0 rather than a lower priority level.

FIG. 3 is a flowchart of an example health evaluation method 300 that can be performed by one or more of the components in FIG. 2 in the virtualized computing environment of FIG. 1. For instance, the method 300 may be an algorithm performed at least in part by the heath evaluator 154 in cooperation with the other components shown in FIG. 2.

The example method 300 may include one or more operations, functions, or actions illustrated by one or more blocks, such as blocks 302 to 310. The various blocks of the method 300 and/or of any other process(es) described herein may be combined into fewer blocks, divided into additional blocks, supplemented with further blocks, and/or eliminated based upon the desired implementation. In one embodiment, the operations of the method 300 and/or of any other process(es) described herein may be performed in a pipelined sequential manner. In other embodiments, some operations may be performed out-of-order, in parallel, etc.

The method 300 may begin at a block 302 (“OBTAIN STORAGE HEALTH INFORMATION”), wherein the health evaluator 154 receives, from one or more of the agent(s) 140, storage health information such as performance metrics and other health-related information pertaining to the distributed storage system 152. The health evaluator 154 may also receive, at the block 302, other health-related information such as health information regarding the hosts, network(s), and/or other components in the virtualized computing environment 100.

The block 302 may be followed by a block 304 (“DETECT HEALTH ISSUE AND IDENTIFY CATEGORY”), wherein based on the received health information, the health evaluator 154 may detect or otherwise determine that a health issue exists. For example, the health evaluator 154 may determine that the distributed storage system is at full capacity, one or more storage nodes or hosts are down (e.g., inaccessible), data throughput is less than expected, etc.

At the block 304, the health evaluator 154 may also identify, for each health issue, the impacted area and scope. For example, the health evaluator 154 may assign each of the detected health issues or other conditions to a particular one or more categories. Such categories may be categories 1-3 described above respectively pertaining to data accessibility/availability, data performance, space utilization/efficiency, etc.

The block 304 may be followed by a block 306 (“DETERMINE PRIORITY LEVEL”), wherein the health evaluator 154 determines the priority level to assign to each of the health issues. For example, the priority level of a health issue (and hence the priority level of the corresponding remedial action to address the health issue) may be one of the priority levels P0-P4. As previously explained above, the priority level assigned to a health issue may be based on an actual impact to an end user (e.g., no data availability/accessibility, increased latency, lower throughput, etc.).

The block 306 may be followed by a block 308 (“GENERATE SUMMARY”), wherein the health evaluator 154 generates an overall summary that may be presented to a system administrator via the management server 142. The information included in the summary may include, but not be limited to, a number of health issues detected, identification of each specific health issue, priority level P0-P4 assigned to the health issue, location of the health issue in the virtualized computing environment 100, which of the categories 1-4 under which the health issue is assigned, etc.

In some embodiments, the overall summary may be provided as part of an alert when one or more health issues are detected. It is also possible for the overall summary to be generated according to a schedule, for example hourly, daily, weekly, etc.

The block 308 may be followed by a block 310 (“RECOMMEND REMEDIAL ACTION”), wherein the health evaluator 154 in cooperation with the management server provides a recommendation for a remedial action to address the health issue and when to perform the remedial action. For example, if the health issue is a resource utilization issue indicating that a low amount of storage capacity remains available for use, the recommendation provided at the block 310 may be a recommendation to the system administrator to provision a certain amount of additional storage capacity within 24 hours. In some embodiments, the recommendations provided at the block 310 may form part of the overall summary provided at the block 308.

Further details are provided next with respect to how the health evaluator 154 detects and identifies health issues that fall within the three categories 1-3 (e.g., blocks 302-306), and reports (e.g., via the summary at the block 308) the corresponding remedial actions with corresponding priority levels.

Data Availability and Accessibility Evaluation

According to various embodiments, the health evaluator 154 (in cooperation with the management server 142) attempts to ensure that new data can be written as long as there is sufficient free storage space in the distributed storage system 152 and that old/existing data can be read from storage. To perform this task of ensuring data accessibility/availability, the health evaluator 154 uses the agents 140 to monitor the hardware health status of the host/devices that are used for storing data.

However, it may be rather complicated to evaluate data accessibility for a distributed storage system having a high availability (HA) design, since data may be split into multiple pieces or replicated as multiple copies that are stored on multiple hosts, for purposes of better performance or better fault tolerance. Hence, if there is a network partition amongst hosts (which means that some of the hosts are isolated from other hosts due to a network connectivity issue), the data may only be accessible from some specific hosts. In such a case, the health evaluator 154 determines how that stored data is accessed (or referred to) by a consumer of the data. For example, one type of distributed storage system is an object storage system whose data object is attached as a virtual disk consumed by a virtual machine (VM). Then, if the VM is placed in a host that can access the data, then there is no data availability issue. However, if the VM is placed in a host that cannot access the data, then there is a data availability issue for that VM.

Example priority levels for a data availability and accessibility issue may defined according to the following:
Priority 0 (P0): At least one or all data copies are lost. Immediate action (P0) is needed to either rebuild the data or recover data from a backup source so as to reduce the data loss risk.
Priority 1 (P1): All data copies are available, without a data loss concern. However, the data cannot be accessed by all the consumers due to an issue like network partitions. A must-have action (P1) is needed to fix the data accessibility issue sooner or later.
Priority 2 (P2): The data object is not compliant with a non-availability related storage policy, such as a state that may violate a certain service level agreement (SLA) condition, like no expected performance, no checksum, or compression/encryption issue, etc., which needs a payment in order the action item to receive attention.

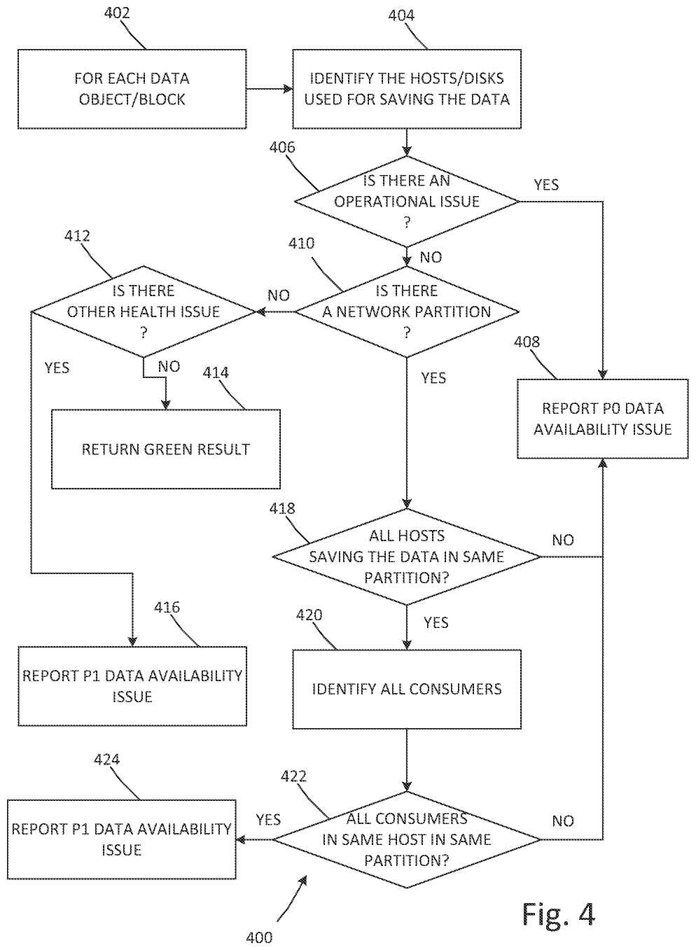

FIG. 4 is a flowchart of an example method 400 to evaluate the health of the distributed storage system's 152 data availability and accessibility, based at least on the considerations and other discussion above. At least some of the operations of the method 400 may correspond to operations performed at blocks 302-308 of the method 300 of FIG. 3.

The method 400 may begin at a block 402 (“FOR EACH DATA OBJECT/BLOCK”) and a block 404 (“IDENTIFY THE HOSTS/DISKS USED FOR SAVING THE DATA”), wherein for each piece of data (such as a data object or a data block), the health evaluator 154 identifies the hosts and/or disks that are used for saving that data. Such information may be provided to the health evaluator 154 by the management server 142, by the distributed storage system 152, by the agents 140, and/or by other components.

The blocks 402/404 may be followed by a block 406 (“IS THERE AN OPERATIONAL ISSUE?”), wherein the health evaluator 154 determines whether the health information provided by the agents 140 indicates whether there is an operational/health issue for the hosts/disks. If there is an operational issue (“YES” at the block 406), such as one or more hosts/disks that store the data is down, then the health evaluator 154 assigns a priority level P0 to this health issue and reports (such as via a summary or alert) the priority level P0 for the data availability issue, at a block 408 (“REPORT P0 DATA AVAILABILITY ISSUE”).

If, however, there is no operation issue for the hosts/disks detected at the block 406 (“NO” at the block 406), then the method 400 proceeds to determine whether a network partition exists, at a block 410 (“IS THERE A NETWORK PARTITION?”). If the health evaluator 154 determines that there is no network partition (“NO” at the block 410), then the method 400 proceeds to determine if there are any other health issues for the hosts/disks that exist or that may be predicted, at a block 412 (“IS THERE OTHER HEALTH ISSUE?”)

If there are no other health issues (“NO” at the block 412), then the health evaluator 154 generates an output indicating that no health issues exist and that no action needs to be taken, at a block 414 (“RETURN GREEN RESULT”). If, however, other health issues are determined to exist (“YES” at the block 412), then the health evaluator 154 assigns a priority level P1 to this health issue and reports (such as via a summary or alert) the priority level P1 for the data availability issue at a block 416 (“REPORT P1 DATA AVAILABILITY ISSUE”). The data availability issue may be a performance related issue, for example, such as latency or reduced throughput.

Back at the block 410, if the health evaluator 154 determines that a network partition exists (“YES” at the block 410), then a series of operations are performed to determine whether the hosts that store the data are in the same or different partitions, whether the consumers (e.g., VMs) of the data are in the same or different hosts in the same partition, etc. Generally, if all of the consumers are able to access the data, then a lower priority level can be given to this health issue, as compared to a higher priority level condition wherein less than all of the consumers are able to access the data due to the isolation/separation caused by the network partition. This determination process is described next.

At a block 418 (“ALL HOSTS SAVING THE DATA IN SAME PARTITION?”), the health evaluator 154 determines whether all of the hosts that store the data are in the same partition. If such hosts are in different partitions (“NO” at the block 418), then such a condition results in some consumers at some hosts being able to access the data and other consumers at other hosts being unable to access the data. Accordingly, the method 400 proceeds to assign a priority level P0 to this health issue and reports (such as via a summary or alert) the priority level P0 for the data availability issue, at the block 408 (“REPORT P0 DATA AVAILABILITY ISSUE”).

However, if all of the hosts that store the data are in the same partition (“YES” at the block 418), then the health evaluator 154 identifies all of the consumers (e.g., VMs) of the data, at a block 420 (“IDENTIFY ALL CONSUMERS”). Next, the health evaluator 154 determines whether all of the consumers are in the same host in the same partition, at a block 422 (“ALL CONSUMERS IN SAME HOST IN SAME PARTITION?”). If all of the consumers are in the same host (storing the data) in the same partition (“YES” at the block 422), then such a condition results in all of these consumers being able to access the data despite the presence of the network partition. The method 400 then proceeds to assign a priority level P1 to this health issue and reports (such as via a summary or alert) the priority level P1 for the data availability issue, at a block 424 (“REPORT P1 DATA AVAILABILITY ISSUE”).

If, back at the block 422, the health evaluator 154 determines that not all of the consumers are in the same host in the same partition (“NO” at the block 422), then such a condition results in an impact in which in some consumers are able to access the data and other consumers are unable to access the data. The method 400 then proceeds to assign a priority level P0 to this health issue and reports (such as via a summary or alert) the priority level P0 for the data availability issue at the block 408 (“REPORT P0 DATA AVAILABILITY ISSUE”), so as to give this health issue a highest (immediate) priority level for performing a remedial action.

Storage Performance Evaluation

Typically, there may be two metrics (e.g., latency and throughput) that can be used for evaluating storage performance. However, throughput is often directly related to user workload so may not be a reliable indicator. Instead, various embodiments use latency as the main indicator for evaluation of the performance health of the distributed storage system 152, because the throughput issue in the distributed storage system 152 will eventually cause high latency in some way. The health evaluator 154 is thus configured to measure for any performance downgrade (latency) that needs to be addressed through a remedial action. Such an approach may involve:
1. Monitoring if the overall average storage system latency exceeds a threshold.
2. Monitoring if there are individual I/Os with higher latency than the threshold.

However, it may be difficult in some situations to determine a proper latency threshold so as to either avoid a false negative or a false positive. There may be two typical false negative cases for latency:
Case A: Average latency may increase at a certain time period along with increased workload size. Such a condition may be acceptable as long as the workload size does not exceed the maximum performance capacity or only lasts for a relatively short period.
Case B: Individual I/O latency may spike due to unstable environments for example due to network issues, or due to specific I/O patterns such as a large number of random write/read operations with too many cache misses.

For case A, the health evaluator 154 leverages the throughput metric to determine if the average latency is expected or not. For case B, the health evaluator 154 first builds the latency historical data per owner data object/block, and then checks the owner object/block distribution for all of high latency I/Os. Hence, the following two example cases may be possible:
There are continuous high latency I/Os observed in many random data objects/blocks. Such a condition indicates a performance issue.
There is continuous high latency I/Os observed in fixed data objects/blocks. Such high latency may or may not be expected. The health evaluator 154 may break down the I/Os and then analyze the major bottleneck(s).

Furthermore, since the I/O latency is impacted by I/O size, the health evaluator 154 is configured measure the latency based on I/O size. For example, the health evaluator 154 may build a respective I/O latency evaluation model for small and large I/Os (e.g., different storage can define the different small and large I/O sizes).

Example priority levels for a performance issue may defined according to the following:
Priority 0 (P0): The I/O latency is lengthy enough to exceed (or nearly reach) the timed out time in all layers of an I/O stack, for example, the I/O stuck from the storage controller, which is a condition that is perceived to be similar to the data accessibility issue from the user perspective.
Priority 1 (P1): There is a continuous high average read/write (R/W) latency with an obvious throughput drop or continuous high latency I/O observed from several random owner data objects/blocks.
Priority 2 (P2): The workload size exceeds the maximum supported or causes continuous high latency due to workload I/O characteristics.

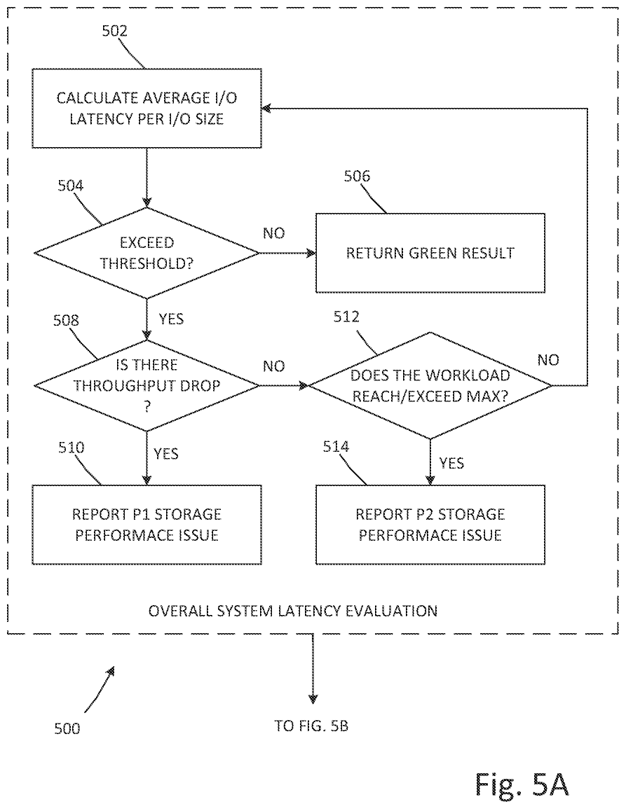

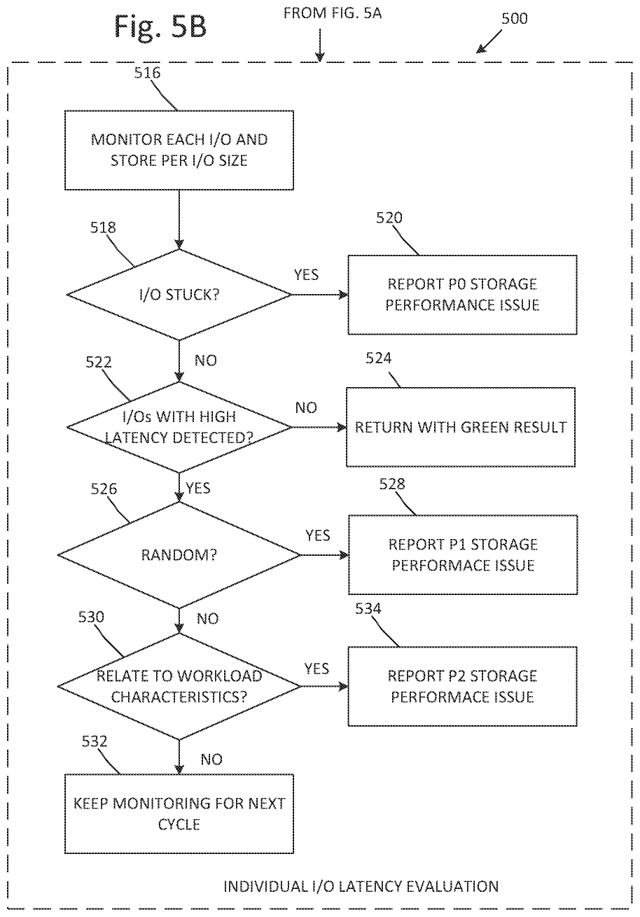

FIGS. 5A and 5B are flowcharts of an example method 500 to evaluate the health of the distributed storage system's 152 performance, based at least on the considerations and other discussion above. At least some of the operations of the method 500 may correspond to operations performed at blocks 302-308 of the method 300 of FIG. 3. The operations depicted in FIG. 5A are directed towards evaluating the overall latency of the distributed storage system 152, while the operations in FIG. 5B are directed towards evaluating individual I/O latency.

With reference first to FIG. 5A, the method 500 may begin at a block 502 (“CALCULATE AVERAGE I/O LATENCY PER I/O SIZE”), wherein the health evaluator 154 calculates the average I/O latency (such as R/W latency) per I/O size over a certain period of time. The block 502 may be followed by a block 504 (“EXCEED THRESHOLD?”), wherein the health evaluator 154 determines whether the average I/O latency for a certain I/O size exceeds a threshold.

If the average I/O latency does not exceed the threshold (“NO” at the block 504), then the health evaluator 154 generates an output indicating that no performance health issues exist and that no action needs to be taken, at a block 506 (“RETURN GREEN RESULT”).

However, if back at the block 504, the health evaluator 154 determines that the threshold has been exceeded (“YES” at the block 504) or is close to being reached, then the method 500 proceeds to a block 508 (“IS THERE THROUGHPUT DROP?”). At the block 508, the health evaluator 154 determines whether there is an obvious or otherwise significant throughput drop during the same time period. If the health evaluator 154 determines that there is a throughput drop (“YES” at the block 508), then the method 500 proceeds to assign a priority level P1 to this performance health issue and reports (such as via a summary or alert) the priority level P1 for the health issue, at a block 510 (“REPORT P1 STORAGE PERFORMANCE ISSUE”).

If, back at the block 508, the health evaluator 154 determines that there is no throughput drop (“NO” at the block 508), then the method 500 proceeds to a block 512 (“DOES THE WORKLOAD REACH/EXCEED MAX?”), wherein the health evaluator 154 determines whether the workload is close to reaching or has exceeded the maximum level of supported workload.

If the maximum supported workload is determined to not have been exceeded (“NO” at the block 512), then the method 500 repeats starting at the block 502. However, if the maximum workload size is determined to have been exceeded (“YES” at the block 512) or is close to being reached, then the method 500 proceeds to assign a priority level P2 (a relatively lower priority level) to this performance health issue and reports (such as via a summary or alert) the priority level P2 for the health issue, at a block 514 (“REPORT P2 STORAGE PERFORMANCE ISSUE”).

The method 500 then proceeds to evaluate individual I/O latency, such as shown next in FIG. 5B.

At a block 516 (“MONITOR EACH I/O AND STORE PER I/O SIZE”) in FIG. 5B, the health evaluator 154 monitors each of the I/Os, and records/stores the I/Os in a database per I/O size with each owner object/block. The operations at the block 516 thus may involve some of the operations for the building of historical latency data.

The block 516 may be followed by a block 518 (“I/O STUCK?”), wherein the health evaluator 154 determines whether an I/O is stuck. As previously explained above, a stuck I/O can be perceived by a user as inaccessible data. As such, if the health evaluator 154 determines that the I/O is stuck (“YES” at the block 518), then the method 500 proceeds to assign a priority level P0 (an urgent priority level) to this performance health issue and reports (such as via a summary or alert) the priority level P0 for the health issue, at a block 520 (“REPORT P0 STORAGE PERFORMANCE ISSUE”).

If, however, the I/O is determined to not be stuck (“NO” at the block 518), then the method 500 proceeds to a block 522 (“I/Os with high latency detected?”). For example, the health evaluator 154 determines whether there are individual I/Os with high latency that have been continuously detected. If no such high latency I/Os are detected (“NO” at the block 522), then the health evaluator 154 generates an output indicating that no performance health issues exist and that no action needs to be taken, at a block 524 (“RETURN GREEN RESULT”).

If, however, I/Os with high latency have been continuously detected (“YES” at the block 522, then the health evaluator 154 determines whether these high latency I/Os come from random owner objects/blocks, at a block 526 (“RANDOM?”). If determined to come from random owner objects/blocks (“YES” at the block 526), then such a condition is indicative of a performance issue. As such, the method 500 proceeds to assign a priority level P1 to this performance health issue and reports (such as via a summary or alert) the priority level P1 for the health issue, at a block 528 (“REPORT P1 STORAGE PERFORMANCE ISSUE”).

If the high latency I/Os are determined to not come from random owner objects/blocks (“NO” at the block 526), then the method 500 proceeds to a block 530 (“RELATE TO WORKLOAD CHARACTERISTICS?”). At the block 530, the health evaluator 154 determines whether the high latency I/Os relate to workload characteristics. If determined to not be related to workload characteristics (“NO” at the block 530), then the method 500 proceeds to a block 532 (“KEEP MONITORING FOR NEXT CYCLE”), in which the health evaluator 154 continues monitoring the I/Os.

Otherwise if the high latency I/O relates to workload characteristics (“YES” at the block 530), the method 500 proceeds to assign a priority level P2 to this performance health issue and reports (such as via a summary or alert) the priority level P2 for the health issue, at a block 534 (“REPORT P2 STORAGE PERFORMANCE ISSUE”).

Storage Utilization and Efficiency Evaluation

According to various embodiments, the health evaluator 154 may evaluate at least the following regarding storage utilization and efficiency:
1. Whether there is enough storage space to avoid a potential risk. For example, the whole distributed storage system 152 may not be operational at all if the storage space is used up or unable to protect data caused by any sudden hardware failure due to lack of space.
2. Whether the storage space is used efficiently when the storage space reaches a relevant high utilization level.

Example priority levels for a storage utilization and efficiency issue may defined according to the following:
Priority 0 (P0): The storage capacity is reaching a nearly full level, which makes the whole distributed storage system 152 not operational.
Priority 1 (P1): The storage capacity is reaching a threshold that cannot satisfy a data availability tolerance SLA defined in the distributed storage system 152. According to this health issue, there is insufficient free space to rebuild the data after one data copy is lost due to any type of hardware failure.
Priority 2 (P2): The storage utilization is reaching a certain threshold (e.g., 50% full) or has optimization room for better space efficiency.

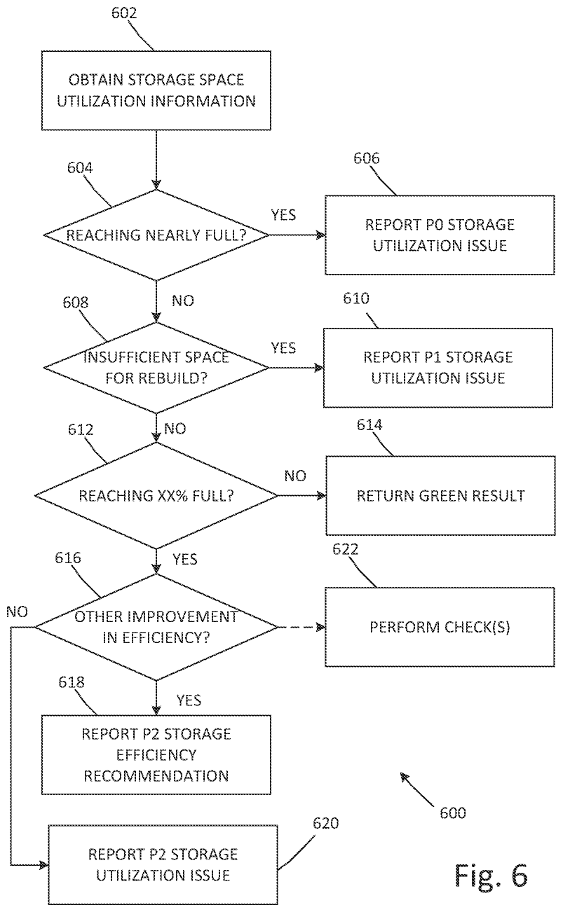

FIG. 6 is a flowchart of an example method 600 to evaluate the health of a distributed storage system's storage space utilization and efficiency, based at least on the considerations and other discussion above. At least some of the operations of the method 600 may correspond to operations performed at blocks 302-308 of the method 300 of FIG. 3.

The method 600 may begin at a block 602 (“OBTAIN STORAGE SPACE UTILIZATION INFORMATION”), wherein the health evaluator 154 obtains storage space utilization information from the agents 140. The block 602 may be followed by a block 604 (“REACHING NEARLY FULL?”), wherein the health evaluator 154 determines whether the storage utilization will reach or has reached a nearly full condition. In such a nearly full condition, the entire distributed storage system 152 may become non-operational or non-functional.

If the storage utilization is determined to be reaching the nearly full condition (“YES” at the block 604), then the method 600 proceeds to assign a priority level P0 to this storage utilization health issue and reports (such as via a summary or alert) the priority level P0 for the health issue, at a block 606 (“REPORT P0 STORAGE UTILIZATION ISSUE”).

If, however, the storage utilization is determined to not be reaching the nearly full condition (“NO” at the block 604), then the method 600 proceeds to a block 608 (“INSUFFICIENT SPACE FOR REBUILD?”). At the block 608, the health evaluator 154 determines whether the storage utilization will reach or has reached a threshold in which there is insufficient storage space to rebuild data in case a disk/host failure occurs. If the storage utilization is determined to be near such threshold (“YES” at the block 608), then the method 600 proceeds to assign a priority level P1 to this storage utilization health issue and reports (such as via a summary or alert) the priority level P1 for the health issue, at a block 610 (“REPORT P1 STORAGE UTILIZATION ISSUE”).

If, however, the storage utilization is determined to not have reached or approached the threshold (“NO” at the block 608), then the method 600 proceeds to a block 612 (“REACHING XX% FULL?”). At the block 612, the health evaluator 154 determines whether the storage utilization will reach or has reached a certain percentage level, such as 50% full. If not reached/approaching the percentage level (“NO” at the block 612), then the health evaluator 154 generates an output indicating that no storage utilization health issues exist and that no action needs to be taken, at a block 614 (“RETURN GREEN RESULT”).

If, however, the health evaluator 154 determines that the storage utilization will reach or has reached a certain percentage level (“YES” at the block 612), then the method 600 proceeds to a block 616 (“OTHER IMPROVEMENT IN EFFICIENCY?”), wherein the health evaluator 154 determines whether there is any opportunity to improve the storage space efficiency. If such opportunities are determined to be available (“YES” at the block 616), then the method 600 proceeds to assign a priority level P2 to this storage efficiency health issue and reports (such as via a summary or alert) the priority level P2 for the health issue along with a recommendation for improving storage efficiency, at a block 618 (“REPORT P2 STORAGE EFFICIENCY RECOMMENDATION”).

Otherwise if there are no opportunities to improve the storage space efficiency (“NO” at the block 616), the method 600 proceeds to assign a priority level P2 to this storage utilization health issue and reports (such as via a summary or alert) the priority level P2 for the health issue, at a block 620 (“REPORT P2 STORAGE UTILIZATION ISSUE”).

Various checks can be performed at a block 622 (“PERFORM CHECK(S)”) to determine whether the storage efficiency may be improved. For example, the health evaluator can check one or more of: whether there is a data object/block that has reserved more storage space than what is expected/needed, whether there is cold data that has not experienced any I/O for a lengthy period of time, whether storage efficiency features such as deduplication or compression has been enabled, etc.

Therefore, in accordance with the various embodiments described above, a user-oriented approach to evaluate the health of a distributed storage system is provided. Such an approach can help a system administrator or other technical support staff to easily identify an issue and take corrective action. Compared to existing solutions, the approach(es) described herein: enables evaluation of the system health based on real user impacts (e.g., the impact to the storage data as well as the application using that data), which is good fit for a large scale distributed storage system; simplifies a complicated storage system's health into categories (e.g., three categories) that are the most user friendly and useful categories; and provides a generic and systematic way of to evaluate a distributed storage system.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1 to 6.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment and/or a distributed storage system), wherein it would be beneficial to categorize and prioritize health issues based on impact.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method to evaluate health issues in a distributed storage system provided in a virtualized computing environment, the method comprising:
obtaining health information that pertains to the distributed storage system;
based on the health information, identifying at least one health issue in the distributed storage system;
identifying a particular category, amongst a plurality of categories, to assign the identified at least one health issue;
based at least in part on the particular category and a user impact due to the at least one health issue, assigning a priority level to the at least one health issue; and
based on the assigned priority level, providing a recommendation for a remedial action to address the health issue.

2. The method of claim 1, further comprising generating a summary, wherein the summary includes a number of the identified at least one health issue, the particular category to which the at least one health issue is assigned, the priority level assigned to the at least one health issue, and the recommendation for the remedial action.

3. The method of claim 1, wherein the assigned priority level is one priority level of a plurality of priority levels, and wherein the plurality of priority levels include:
a first priority level that corresponds to a first health issue with immediate urgency;
a second priority level that corresponds to a second health issue, with less criticality relative to the first health issue, and that is without immediate urgency;
a third priority level that corresponds to a third health issue, with less criticality relative to the second health issue;
a fourth priority level that corresponds to a fourth health issue, with less criticality relative to the third health issue, and that is an informational issue; and
a fifth priority level that corresponds to a condition in which there is no health issue that is identified.

4. The method of claim 1, wherein the plurality of categories include:
a first category corresponding to storage data availability and accessibility;
a second category corresponding to storage data performance; and
a third category corresponding to storage space utilization and efficiency.

5. The method of claim 4, wherein with respect to the first category, assigning the priority level to the at least one health issue includes:
determining whether there an operational issue exists for a disk or host that stores data;
in response to determination that the operational issue exists, reporting the assigned priority level as an urgent priority level;
in response to determination that the operational issue is absent, determining whether a network partition exists; and
dependent on whether the network partition is determined to exist and dependent on whether all consumers of the data are able to access the data, reporting the assigned priority level as the urgent priority level or as a relatively less urgent priority level.

6. The method of claim 4, wherein with respect to the second category, assigning the priority level to the at least one health issue includes:
evaluating an overall latency of the distributed storage system; and
evaluating individual input/output (I/O) latencies in the distributed storage system.

7. The method of claim 4, wherein with respect to the third category, assigning the priority level to the at least one health issue includes:
determining whether storage space in the distributed storage system is nearing a full condition;
in response to determination that the storage space in nearing the full condition, reporting the assigned priority level as an urgent first priority level; and
in response to determination that the storage space is substantially less than the full condition:
reporting the assigned priority level as a second priority level, which is less urgent relative to the first priority level, if there is insufficient storage space to rebuild data in response to a failure; and
reporting the assigned priority level as a third priority level, which is less urgent relative to the second priority level, if there is sufficient storage space to rebuild data in response to the failure and if an opportunity exist to improve an efficiency of the distributed storage system.

8. A non-transitory computer-readable medium having instructions stored thereon, which in response to execution by one or more processors, cause the one or more processors to perform or control performance of a method to evaluate health issues in a distributed storage system provided in a virtualized computing environment, wherein the method comprises:
obtaining health information that pertains to the distributed storage system;
based on the health information, identifying at least one health issue in the distributed storage system;
identifying a particular category, amongst a plurality of categories, to assign the identified at least one health issue;
based at least in part on the particular category and a user impact due to the at least one health issue, assigning a priority level to the at least one health issue; and
based on the assigned priority level, providing a recommendation for a remedial action to address the health issue.

9. The non-transitory computer-readable medium of claim 8, wherein the method further comprises:
generating a summary, wherein the summary includes a number of the identified at least one health issue, the particular category to which the at least one health issue is assigned, the priority level assigned to the at least one health issue, and the recommendation for the remedial action.

10. The non-transitory computer-readable medium of claim 8, wherein the assigned priority level is one priority level of a plurality of priority levels, and wherein the plurality of priority levels include:
a first priority level that corresponds to a first health issue with immediate urgency;
a second priority level that corresponds to a second health issue, with less criticality relative to the first health issue, and that is without immediate urgency;
a third priority level that corresponds to a third health issue, with less criticality relative to the second health issue;
a fourth priority level that corresponds to a fourth health issue, with less criticality relative to the third health issue, and that is an informational issue; and
a fifth priority level that corresponds to a condition in which there is no health issue that is identified.

11. The non-transitory computer-readable medium of claim 8, wherein the plurality of categories include:
a first category corresponding to storage data availability and accessibility;
a second category corresponding to storage data performance; and
a third category corresponding to storage space utilization and efficiency.

12. The non-transitory computer-readable medium of claim 11, wherein with respect to the first category, assigning the priority level to the at least one health issue includes:
determining whether there an operational issue exists for a disk or host that stores data;
in response to determination that the operational issue exists, reporting the assigned priority level as an urgent priority level;
in response to determination that the operational issue is absent, determining whether a network partition exists; and
dependent on whether the network partition is determined to exist and dependent on whether all consumers of the data are able to access the data, reporting the assigned priority level as the urgent priority level or as a relatively less urgent priority level.

13. The non-transitory computer-readable medium of claim 11, wherein with respect to the second category, assigning the priority level to the at least one health issue includes:
evaluating an overall latency of the distributed storage system; and
evaluating individual input/output (I/O) latencies in the distributed storage system.

14. The non-transitory computer-readable medium of claim 11, wherein with respect to the third category, assigning the priority level to the at least one health issue includes:
determining whether storage space in the distributed storage system is nearing a full condition;
in response to determination that the storage space in nearing the full condition, reporting the assigned priority level as an urgent first priority level; and
in response to determination that the storage space is substantially less than the full condition:
reporting the assigned priority level as a second priority level, which is less urgent relative to the first priority level, if there is insufficient storage space to rebuild data in response to a failure; and
reporting the assigned priority level as a third priority level, which is less urgent relative to the second priority level, if there is sufficient storage space to rebuild data in response to the failure and if an opportunity exist to improve an efficiency of the distributed storage system.

15. A computing device to evaluate health issues in a distributed storage system provided in a virtualized computing environment, the computing device comprising:
one or more processors; and
a non-transitory computer-readable medium coupled to the one or more processors, and having instructions stored thereon, which in response to execution by the one or more processors, cause the one or more processors to perform or control performance of operations that include:
obtain health information that pertains to the distributed storage system;
based on the health information, identify at least one health issue in the distributed storage system;
identify a particular category, amongst a plurality of categories, to assign the identified at least one health issue;
based at least in part on the particular category and a user impact due to the at least one health issue, assign a priority level to the at least one health issue; and
based on the assigned priority level, provide a recommendation for a remedial action to address the health issue.

16. The computing device of claim 15, wherein the operations further include:
generate a summary, wherein the summary includes a number of the identified at least one health issue, the particular category to which the at least one health issue is assigned, the priority level assigned to the at least one health issue, and the recommendation for the remedial action.

17. The computing device of claim 15, wherein the assigned priority level is one priority level of a plurality of priority levels, and wherein the plurality of priority levels include:
a first priority level that corresponds to a first health issue with immediate urgency;
a second priority level that corresponds to a second health issue, with less criticality relative to the first health issue, and that is without immediate urgency;
a third priority level that corresponds to a third health issue, with less criticality relative to the second health issue;
a fourth priority level that corresponds to a fourth health issue, with less criticality relative to the third health issue, and that is an informational issue; and
a fifth priority level that corresponds to a condition in which there is no health issue that is identified.

18. The computing device of claim 15, wherein the plurality of categories include:
a first category corresponding to storage data availability and accessibility;
a second category corresponding to storage data performance; and
a third category corresponding to storage space utilization and efficiency.

19. The computing device of claim 18, wherein with respect to the first category, the operations to assign the priority level to the at least one health issue comprise operations that include:
determine whether there an operational issue exists for a disk or host that stores data;
in response to determination that the operational issue exists, report the assigned priority level as an urgent priority level;
in response to determination that the operational issue is absent, determine whether a network partition exists; and
dependent on whether the network partition is determined to exist and dependent on whether all consumers of the data are able to access the data, report the assigned priority level as the urgent priority level or as a relatively less urgent priority level.

20. The computing device of claim 18, wherein with respect to the second category, the operations to assign the priority level to the at least one health issue comprise operations that include:
evaluate an overall latency of the distributed storage system; and
evaluate individual input/output (I/O) latencies in the distributed storage system.

21. The computing device of claim 18, wherein with respect to the third category, the operations to assign the priority level to the at least one health issue comprise operations that include:
determine whether storage space in the distributed storage system is nearing a full condition;
in response to determination that the storage space in nearing the full condition, report the assigned priority level as an urgent first priority level; and
in response to determination that the storage space is substantially less than the full condition:
report the assigned priority level as a second priority level, which is less urgent relative to the first priority level, if there is insufficient storage space to rebuild data in response to a failure; and
report the assigned priority level as a third priority level, which is less urgent relative to the second priority level, if there is sufficient storage space to rebuild data in response to the failure and if an opportunity exist to improve an efficiency of the distributed storage system.
